(19) United States
(12) Patent Application Publication
(10) Pub. No.: US 2025/0243993 A1
(43) Pub. Date: Jul. 31, 2025

(54) LENS CAPABLE OF ROTATABLY ADJUSTING LIGHT EMITTING ANGLE, OPTICAL SYSTEM, AND IMPLEMENTATION METHOD THEREOF

(71) Applicant: Hengdian Group Tospo Lighting Co., Ltd.

(72) Inventors: Kan Li, Jinhua (CN); Junchu Si, Jinhua (CN); Yidi Chen, Jinhua (CN); Xinqiang Guo, Jinhua (CN); Haotian Zhou, Jinhua (CN); Quanfei Hu, Jinhua (CN)

(21) Appl. No.: 19/031,484

(22) Filed: Jan. 18, 2025

(30) Foreign Application Priority Data
Jan. 25, 2024 (CN) 202410108349.0

(51) Int. Cl. F21V 14/06; F21V 5/04

(52) U.S. Cl. CPC F21V 14/06; F21V 5/046

(57) ABSTRACT

A lens capable of rotatably adjusting a light emitting angle is disclosed, and the lens includes a lens body, where the lens body is provided with a plurality of lens rings in an equal spacing manner from inside to outside; each lens ring includes a plurality of first lens portions and a plurality of second lens portions, which are alternatively arranged and have different light emitting angles; and the first lens portions and the second lens portions on two adjacent lens rings are staggered. An optical system capable of rotatably adjusting a light emitting angle and an implementation method for the optical system capable of rotatably adjusting a light emitting angle are further disclosed. The lens body is matched with a light source plate.

### CROSS-REFERENCE TO RELATED APPLICATION

This Application claims priority to Chinese patent application No. 202410108349.0, filed Jan. 25, 2024, the entirety of which are herein incorporated by reference.

### FIELD OF THE INVENTION

The present disclosure belongs to the technical field of optical lenses, and particularly relates to a lens capable of rotatably adjusting a light emitting angle, an optical system, and an implementation method thereof.

### BACKGROUND OF THE INVENTION

With the development of the lighting market, people's demands on lights is increasing, and the lights with single angles can no longer meet people's daily illumination needs.

At present, an angle of a high bay light is mainly adjusted in the following two manners on the market:
the first manner is to adjust an angle by changing a distance between a lens and a light source to adjust a focal length of the lens. However, by using this manner, optical efficiency will be changed after adjustment on the focal length, resulting in a loss of a light flux; and
the second manner is to adjust the angle by adjusting relative positions of two-layer lenses to change a light path, this manner needs a two-layer optical structure, and there is still a problem of a large loss of the light flux.

### SUMMARY OF THE INVENTION

In order to solve the problems in the background, the present disclosure provides a lens capable of rotatably adjusting a light emitting angle, an optical system, and an implementation method thereof, having a characteristic of lossless adjustment on a light emitting angle.

In order to realize the purpose, the present disclosure provides the following technical solution: the lens capable of rotatably adjusting a light emitting angle includes a lens body, where the lens body is provided with a plurality of lens rings in an equal spacing manner from inside to outside; each lens ring includes a plurality of first lens portions and a plurality of second lens portions, which are alternatively arranged and have different light emitting angles; and the first lens portions and the second lens portions of two adjacent lens rings are staggered. An included angle between extension lines of sides of first lens portion and the second lens portion is 30 degrees.

In order to mount a sealing ring to ensure a waterproof effect of an entire light after being assembled, further, a glue groove is provided on an outer side above the lens body.

In order to achieve limit connection between the lens body and the light source plate, further, symmetrical hooks are arranged at a middle position above the lens body.

In order to expand functionality of the entire light, further, a mounting hole is provided at a circle center of the lens body.

In order to facilitate rotation of the lens body, further, two symmetrical bumps are further arranged on a circumferential side of a bottom surface of the lens body.

In order to guide and limit rotation of the lens body, further, a plurality of guide grooves are provided on a circumference of the lens body; and protrusions are arranged at two ends of the guide grooves.

In order to realize matching with the lens body for use, the light emitting angle can be adjusted by rotating the lens body, further, an optical system capable of rotatably adjusting a light emitting angle, provided by the present disclosure, includes the lens body and the light source plate, where the light source plate is provided with a plurality of circles of light bead groups; each light bead group includes a plurality of light bead strings in an annular array; an included angle between adjacent ends of two adjacent light bead strings is 30 degrees; and the light bead strings of two adjacent light bead groups are staggered from each other.

In order to achieve limit connection between the lens body and the light source plate, further, a through hole is provided in a middle position of the light source plate.

Further, the present disclosure provides an implementation method for an optical system capable of rotatably adjusting a light emitting angle, including the following steps:
(I), a light emitting angle of first lens portions is 60 degrees, and a light emitting angle of second lens portions is 120 degrees;
(II), in an initial state, the first lens portions correspond to the light bead groups, and at this time, a light emitting angle of an entire light is 60 degrees;
(III), when the lens body is rotated by 15 degrees, half of the light bead groups correspond to the first lens portions, and the other half of the light bead groups correspond to the second lens portions; and at this time, the light emitting angle of the entire light is 90 degrees; and
(IV), when the lens body is rotated by 30 degrees, the light emitting angle of the entire light is 120 degrees.

Compared with the prior art, the present disclosure has the beneficial effects:
1. the lens body is matched with the light source plate. By rotating the lens body to adjust positions of the first lens portions and the second lens portions, corresponding to light bead groups on the light source plate, the light emitting angle of an entire light is adjusted.
2. For the present disclosure, the light emitting angle of the entire light is changed correspondingly while the lens body rotates, so as to achieve continuous adjustment on the light emitting angle.
3. For the present disclosure, the light emitting angle is adjusted by rotating the lens body, and only one layer of optical structure exists, which avoids a loss of a light flux, thereby achieving lossless adjustment on the light emitting angle.

### BRIEF DESCRIPTION OF THE DRAWINGS

The accompanying drawings are intended to provide further understanding of the present disclosure and constitute one part of the description. The drawings are used for interpreting the present disclosure together with the embodiments of the present disclosure, not for limiting the present disclosure. In the drawings:

FIGS. 1 and 2 are schematic diagrams of perspective structures of a lens body of the present disclosure;

FIG. 3 is a schematic structural front view of the lens body of the present disclosure;

FIG. 4 is a schematic structural diagram of a lens ring the present disclosure;

FIG. 5 is a schematic partial structural diagram of the lens body of the present disclosure;

FIG. 6 is a schematic structural diagram of a light source plate of the present disclosure; and

FIG. 7 is a schematic structural diagram of a light bead group of the present disclosure.

In Figs., 1, lens body; 101, guide groove; 102, bump; 103, protrusion; 2, lens ring; 21, first lens portion; 22, second lens portion; 3, hook; 4, mounting hole; 5, glue groove; 6, light source plate; 61, through hole; 7, light bead group; 71, light bead chain.

### DETAILED DESCRIPTION OF THE EMBODIMENTS

The technical solutions in embodiments of the present disclosure are clearly and completely described below in combination with the accompanying drawings in the embodiments of the present disclosure. Apparently, the embodiments described are merely a part rather than all of the embodiments of the present disclosure. All other embodiments obtained by those of ordinary skilled in the art based on the embodiments of the present disclosure without making creative efforts shall fall within the scope of protection of the present disclosure.

### Embodiment 1

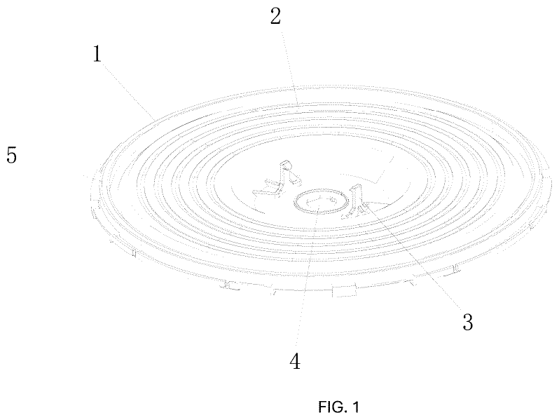

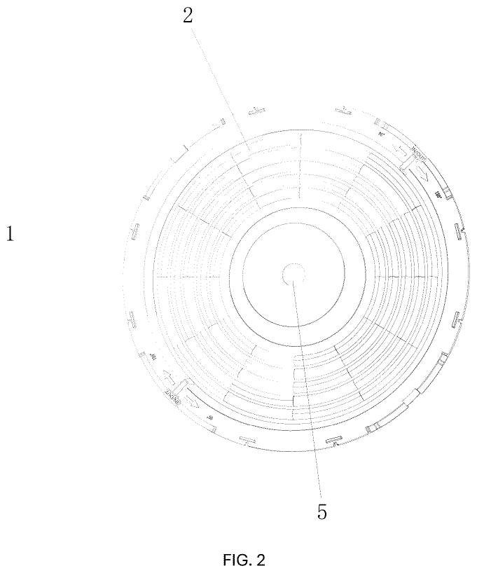

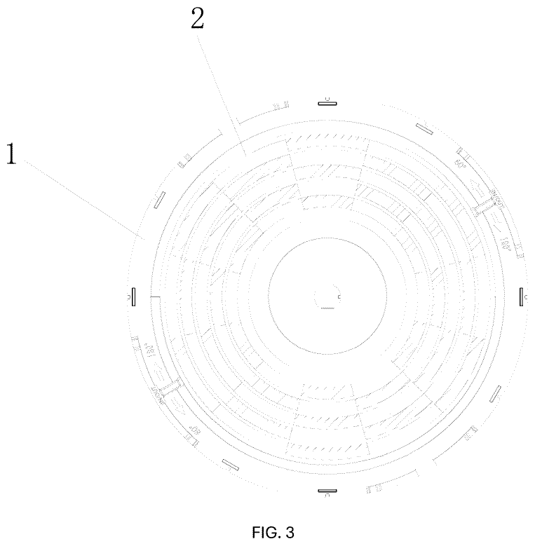

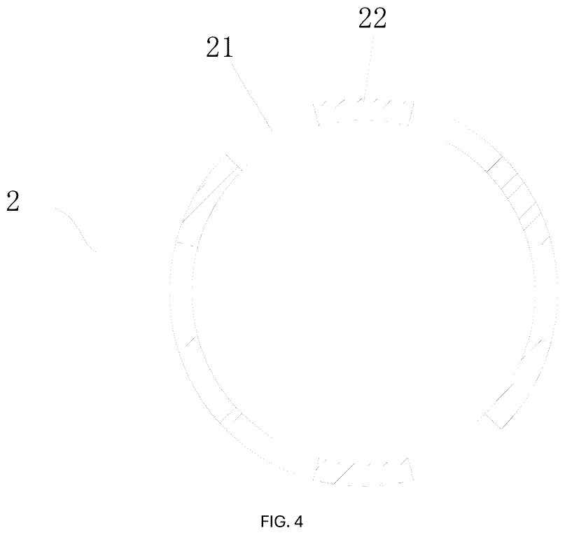

Referring to FIGS. 1-7, the present disclosure provides the following technical solution: a lens capable of being rotated to adjust a light emitting angle includes a lens body 1, where a lens of the lens body 1 is formed by annularly stretching a freeform lens; the lens body 1 is provided with five lens rings 2 in an equal spacing manner from inside to outside; each lens ring 2 includes a plurality of first lens portions 21 and a plurality of second lens portions 22, the first lens portions 21 and the second lens portions 22 of the lens ring 2 are alternatively arranged and have different light emitting angles; the first lens portions 21 and the second lens portions 22 of two adjacent lens rings 2 are staggered from each other; and an included angle between extension lines of two sides of first lens portion 21 is 30 degrees, and an included angle between extension lines of two sides of the second lens portion 22 is also 30 degrees.

By using the above technical solution, the lens body 1 is matched with a light source plate 6. By rotating the lens body 1 to adjust positions of the first lens portions 21 and the second lens portions 22, corresponding to light bead groups 7 on the light source plate 6, an light emitting angle of an entire light is adjusted. For the present disclosure, the light emitting angle of the entire light is changed correspondingly while the lens body 1 rotates, so as to achieve continuous adjustment on the light emitting angle. The light emitting angle is adjusted by rotating the lens body 1, and only one layer of optical structure exists, which avoids a loss of a light flux, thereby achieving lossless adjustment on the light emitting angle.

Specifically, a glue groove 5 is formed in an outer side above the lens body 1.

By using the above technical solution, the glue groove is used for mounting a sealing ring, whereby after assembly of the entire light, a waterproof effect of the entire light is ensured.

Specifically, symmetrical hooks 3 are arranged at a middle position above the lens body 1.

By using the above technical solution, the hooks 3 are matched with a through hole 61 formed in the light source plate 6, so as to achieve limit connection between the lens body 1 and the light source plate 6.

Specifically, two symmetrical bumps 102 are further arranged on a circumferential side of a bottom surface of the lens body 1.

By using the above technical solution, rotation of the lens body 1 is facilitated.

### Embodiment 2

The embodiment is different from embodiment 1 in that: specifically, a mounting hole 4 is formed in a circle center of the lens body 1.

By using the above technical solution, the mounting hole 4 is used for mounting a Zhaga module, for facilitating expansion of functionality of the entire light.

### Embodiment 3

The embodiment is different from embodiment 1 in that: specifically, a plurality of guide grooves 101 are formed in a circumference of the lens body 1; and protrusions 103 are arranged at two ends of the guide groove 101, and provide feedback for rotating the lens body 1 in place.

By using the above technical solution, by matching the guide grooves 101 with guide blocks on a light body (not shown in the drawings), rotation of the lens body 1 can be guided and limited.

### Embodiment 4

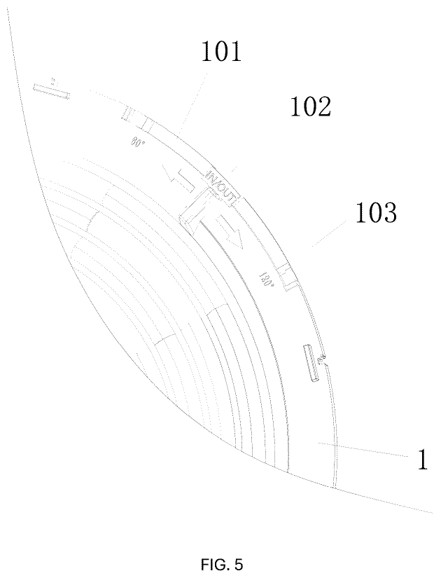

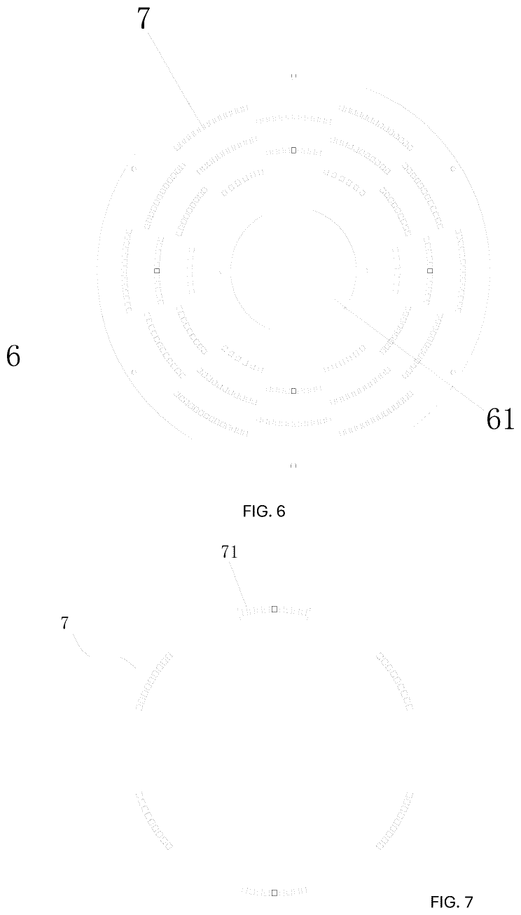

Referring to FIGS. 6-7, the present disclosure provides an optical system capable of rotatably adjusting a light emitting angle, including a lens body 1 and a light source plate 6, where the light source plate 6 is provided with a plurality of circles of light bead groups 7; each light bead group 7 includes a plurality of light bead strings 71 in an annular array; an included angle between adjacent ends of two adjacent light bead strings 71 is 30 degrees; and the light bead strings 71 on two adjacent light bead groups 7 are staggered.

By using the above technical solution, the light source plate 6 is matched with the lens body 1 for use, so as to adjust the light emitting angle by rotating the lens body 1.

Specifically, a through hole 61 is formed in a middle position of the light source plate 6.

By using the above technical solution, the through hole 61 is matched with the hooks 3 arranged above the lens body 1, so as to achieve limit connection between the lens body 1 and the light source plate 6.

### Embodiment 5

Further, the present disclosure provides an implementation method for an optical system capable of rotatably adjusting a light emitting angle, including the following steps:
(I), a light emitting angle of first lens portions 21 is 60 degrees, and a light emitting angle of second lens portions 22 is 120 degrees;
(II), in an initial state, the first lens portions 21 correspond to light bead groups 7, and at this time, a light emitting angle of an entire light is 60 degrees;
(III), when the lens body 1 is rotated by 15 degrees, half of the light bead groups 7 correspond to the first lens portions 21, and the other half of the light bead groups 7 correspond to the second lens portions 22; and at this time, the light emitting angle of the entire light is 90 degrees; and
(IV), when the lens body 1 is rotated by 30 degrees, the light emitting angle of the entire light is 120 degrees.

In summary, the lens body 1 is matched with a light source plate 6. By rotating the lens body 1 to adjust positions of the first lens portions 21 and the second lens portions 22 corresponding to light bead groups 7 on the light source plate 6, an light emitting angle of an entire light is adjusted. For the present disclosure, the light emitting angle of the entire light is changed correspondingly while the lens body 1 rotates, so as to achieve continuous adjustment on the light emitting angle. The light emitting angle is adjusted by rotating the lens body 1, and only one layer of optical structure exists, which avoids a loss of a light flux, thereby achieving lossless adjustment on the light emitting angle.

Finally, it should be noted that the above is only a preferred embodiment of the present disclosure, but not intended to limit the present disclosure. Although the present disclosure is described in detail with reference to the aforementioned embodiments, those skilled in the art may still make modifications to the technical solutions recorded in the above embodiments or equivalent replacements to part of technical features. Any modification, equivalent replacement, improvement, etc. made within the spirit and principles of the present disclosure shall be included in the scope of protection of the resent disclosure.

1. A lens capable of being rotated to adjust a light emitting angle, comprising a lens body, wherein the lens body is provided with a plurality of lens rings in an equal spacing manner from inside to outside; each lens ring comprises a plurality of first lens portions and a plurality of second lens portions, the first lens portions and the second lens portions of the lens ring are alternatively arranged and have different light emitting angles; and the first lens portions and the second lens portions of two adjacent lens rings are staggered from each other.

2. The lens according to claim 1, wherein an included angle between extension lines of sides of each first lens portion is 30 degrees, and an included angle between extension lines of sides of each second lens portion is 30 degrees.

3. The lens according to claim 1, wherein a glue groove is provided on an outer side above the lens body.

4. The lens according to claim 1, wherein symmetrical hooks are arranged at a middle position above the lens body.

5. The lens according to claim 1, wherein a mounting hole is provided at a circle center of the lens body.

6. The lens according to claim 1, wherein two symmetrical bumps are arranged on a circumferential side of a bottom surface of the lens body.

7. The lens according to claim 1, wherein a plurality of guide grooves are provided on a circumference of the lens body; and protrusions are arranged at two ends of the guide grooves.

8. An optical system capable of being rotated to adjust a light emitting angle, comprising the lens body of claim 1, and further comprising: a light source plate, wherein the light source plate is provided with a plurality of circles of light bead groups; each light bead group comprises a plurality of light bead strings in an annular array; an included angle between adjacent ends of two adjacent light bead strings is 30 degrees; and the light bead strings of two adjacent light bead groups are staggered.

9. The optical system according to claim 8, wherein a through hole is provided in a middle position of the light source plate.

10. An implementation method for the optical system according to claim 8, wherein the method comprises:
providing first lens portions with a light emitting angle of 60 degrees and second lens portions with a light emitting angle of 120 degrees;
corresponding the first lens portions to light bead groups such that a light emitting angle of an entire light is 60 degrees;
rotating the lens body by 15 degrees to correspond half of the light bead groups to the first lens portions and to correspond another half of the light bead groups to the second lens portions such that the light emitting angle of the entire light is 90 degrees; and
rotating the lens body by 30 degrees such that the light emitting angle of the entire light is 120 degrees.
